(19) United States
(12) Patent Application Publication
(10) Pub. No.: US 2022/0157223 A1
(43) Pub. Date: May 19, 2022

(54) PIXEL CIRCUIT AND DRIVING METHOD THEREOF, AND DISPLAY DEVICE

(71) Applicant: BOE Technology Group Co., Ltd., Beijing (CN)

(72) Inventors: Zhichong WANG, Beijing (CN); Xinglong LUAN, Beijing (CN); Peng LIU, Beijing (CN); Jing FENG, Beijing (CN); Gaoming SUN, Beijing (CN); Yi OUYANG, Beijing (CN)

(21) Appl. No.: 17/355,637

(22) Filed: Jun. 23, 2021

(30) Foreign Application Priority Data
Nov. 19, 2020 (CN) 202011307869.2

(51) Int. Cl. G09G 3/32

(52) U.S. Cl. CPC G09G 3/32; G09G 2310/0286; G09G 2310/0297; G09G 2330/021; G09G 2310/08; G09G 2320/0257; G09G 2300/0809; G09G 2310/0267

(57) ABSTRACT

The present application discloses a pixel circuit and a driving method thereof, and a display device. The circuit includes: a first initialization sub-circuit, a data writing circuit, a light emitting control circuit, a capacitor circuit, a drive transistor, a compensation circuit, a light emitting element, and a holding circuit; the first initialization sub-circuit is connected to a second terminal of the capacitor circuit and a gate of the drive transistor; the data writing circuit and the holding circuit are connected to a first terminal of the capacitor circuit; the light emitting control circuit is connected to a first electrode of the light emitting element and a second electrode of the drive transistor; a first electrode of the drive transistor is connected to the first power supply; a second electrode of the light emitting element is connected to a second power supply.

### CROSS-REFERENCE TO RELATED APPLICATION

The present application claims the priority of Chinese Patent Application No. 202011307869.2 filed on Nov. 19, 2020, the contents of which are incorporated herein in their entirety by reference.

### TECHNICAL FIELD

The present disclosure generally relates to the field of display technology, in particular to the field of LED internal pixel circuits, and more particularly to a pixel circuit and a driving method thereof, and a display device.

### BACKGROUND

As shown in FIG. 1, a pixel circuit in related art includes a light emitting control drive signal and a gate drive signal. The realization of the drive signal requires two sets of control programs for light emitting control drive and gate drive. The circuit drive scheme is complicated, which increases the risk of drive. At the same time, the pixel circuit has short-term image sticking during initialization, and the gate potential of the drive transistor is not stable.

### SUMMARY

An embodiment of the present disclosure discloses a pixel compensation circuit including:

a first initialization sub-circuit, a data writing circuit, a light emitting control circuit, a capacitor circuit, a drive transistor, a compensation circuit, a light emitting element, and a holding circuit;

the first initialization sub-circuit is connected to a second terminal of the capacitor circuit and a gate of the drive transistor, and is configured to complete initialization of the drive transistor;

the data writing circuit is connected to a first terminal of the capacitor circuit, and is configured to, in a data writing stage, cause the capacitor circuit to store data to be written to the gate of the drive transistor;

the light emitting control circuit is connected to a first electrode of the light emitting element and a second electrode of the drive transistor, and is configured to, in a light emitting stage, control the first electrode of the light emitting element to receive a first power supply to emit light;

a first electrode of the drive transistor is connected to the first power supply, and the second electrode of the drive transistor is connected to the light emitting control circuit;

the compensation circuit is connected to the second electrode and the gate of the drive transistor, and is configured to perform potential compensation on the gate of the drive transistor when the data writing circuit writes data to the first terminal of the capacitor circuit;

a second electrode of the light emitting element is connected to a second power supply;

the holding circuit is connected to the first terminal of the capacitor circuit, and is configured to prevent the first terminal of the capacitor circuit from being not connected, so as to stabilize a gate potential of the drive transistor.

Optionally, the first initialization sub-circuit and the compensation circuit are dual-transistor circuits, wherein, a transistor in the first initialization sub-circuit is also multiplexed as a transistor in the compensation circuit.

Optionally, the first initialization sub-circuit includes a first transistor and a second transistor;

a first electrode of the first transistor is connected to an initial power supply;

a second electrode of the first transistor is connected to a second electrode of the second transistor, a first electrode of the second transistor is connected to the gate of the drive transistor;

the first transistor outputs a potential of the initial power supply to the second electrode of the second transistor in response to a second control signal;

the second transistor outputs the potential of the initial power supply to the gate of the drive transistor in response to a second drive signal.

Optionally, the data writing circuit includes a third transistor and a fourth transistor;

a second electrode of the third transistor is connected to written data;

a first electrode of the third transistor is connected to a second electrode of the fourth transistor, a first electrode of the fourth transistor is connected to the first terminal of the capacitor circuit;

the third transistor writes the written data to the second electrode of the fourth transistor in response to a third drive signal;

the fourth transistor writes the written data to the first terminal of the capacitor circuit in response to a second drive signal.

Optionally, the compensation circuit includes a second transistor and a seventh transistor;

the second transistor is a transistor that is multiplexed by the compensation circuit and the first initialization sub-circuit;

a first electrode of the second transistor is connected to the gate of the drive transistor, a second electrode of the second transistor is connected to a first electrode of the seventh transistor;

a second electrode of the seventh transistor is connected to the second electrode of the drive transistor;

the seventh transistor causes a threshold voltage of the drive transistor to pass through the second electrode of the second transistor in response to a third drive signal;

the second transistor causes the threshold voltage of the drive transistor to be compensated to the gate of the drive transistor in response to a second drive signal.

Optionally, the light emitting control circuit includes a fifth transistor;

a first electrode of the fifth transistor is connected to the second electrode of the drive transistor, a second electrode of the fifth transistor is connected to the first electrode of the light emitting element;

the fifth transistor outputs a potential of the first power supply passing through the drive transistor to the first electrode of the light emitting element in response to a first control signal.

Optionally, the holding circuit includes a sixth transistor, a first electrode of the sixth transistor is connected to a holding power supply, a second electrode of the sixth transistor is connected to the first terminal of the capacitor circuit;

the sixth transistor outputs a potential of the holding power supply to the first terminal of the capacitor circuit in response to a second control signal.

Optionally, the pixel circuit further includes a second initialization sub-circuit;

the second initialization sub-circuit is connected to the first terminal of the capacitor circuit, and is configured to complete initialization of the capacitor circuit;

the data writing circuit and the second initialization sub-circuit are dual-transistor circuits, wherein, a transistor in the second initialization sub-circuit is also multiplexed as a transistor in the data writing circuit.

Optionally, the second initialization sub-circuit includes a fourth transistor and an eighth transistor;

the fourth transistor is a transistor that is multiplexed by the data writing circuit and the second initialization sub-circuit;

a second electrode of the eighth transistor is connected to an initial power supply;

a first electrode of the eighth transistor is connected to a second electrode of the fourth transistor, a first electrode of the fourth transistor is connected to the first terminal of the capacitor circuit;

the eighth transistor outputs a potential of the initial power supply to the second electrode of the fourth transistor in response to a first drive signal;

the fourth transistor outputs the potential of the initial power supply to the first terminal of the capacitor circuit in response to a second drive signal.

An embodiment of the present disclosure further discloses a display device, wherein the device includes the pixel circuit according to any of the embodiments of the present disclosure.

Optionally, the display device includes multiple pixel circuits arranged in an array, the multiple pixel circuits are divided into multiple lines of pixel circuits; the display device further includes a gate driver circuit, a light emitting signal control circuit, and a first drive signal;

the gate driver circuit includes a first shift register unit and a second shift register unit;

the first shift register unit and the second shift register unit are configured to output an input timing signal as a timing signal shifted by one bit, the first shift register unit input the output timing signal into the second shift register unit;

the light emitting signal control circuit includes a first inverter unit and a second inverter unit;

the first inverter unit receives the timing signal output by the first shift register unit, and inverts the timing signal output by the first shift register unit, the second inverter unit receives the timing signal output by the second shift register unit, and inverts the timing signal output by the second shift register unit;

the first drive signal is input to the first shift register unit;

the first shift register unit, the second shift register unit, the timing signals output by the first shift register unit and the second shift register unit are output to each line of the pixel circuit to realize works of an initialization stage, a data writing stage and a light emitting stage of each line of the pixel circuit.

An embodiment of the present disclosure further discloses a driving method of a pixel circuit applied to the pixel circuit according to any of the above embodiments, the driving method including: in each working cycle,

in an initialization stage, connecting an initial power supply to the first initialization sub-circuit, and under the control of a second control signal and a second drive signal, turning on dual transistors of the first initialization sub-circuit, outputting an initial power supply potential Vinitial to the gate of the drive transistor so that a gate potential of the drive transistor is Vinitial, wherein a gate-source voltage difference Vgs of the drive transistor is Vinitial-ELVDD, the ELVDD is the first power supply;

in a data writing stage, connecting written data to the data writing circuit, and under the control of a third drive signal and a second drive signal, turning on dual transistors of the data writing circuit to write the data to the first terminal of the capacitor circuit, and under the control of the third drive signal and the second drive signal, the compensation circuit turning on dual transistors of the compensation circuit, making a threshold voltage of the drive transistor compensated to the gate of the drive transistor so that the gate potential of the drive transistor is ELVDD+Vth, wherein the Vth is the threshold voltage of the drive transistor;

in a light emitting stage, under the control of a first control signal, the light emitting control circuit turning on a transistor of the light emitting control circuit, turning on a connection between the first power supply and the first electrode of the light emitting element, controlling the light emitting element to emit light, and under the control of a second control signal, the holding circuit outputting a potential Vref of a holding power supply to the first terminal of the capacitor circuit, and feeding back a difference between potentials of the first terminal of the capacitor circuit in the light emitting stage and in the data writing stage to the gate of the drive transistor so that the gate potential of the drive transistor is ELVDD+Vth+Vref−Vdata, wherein the gate-source voltage difference Vgs of the drive transistor is Vth+Vref−Vdata;

the second drive signal and the first control signal are mutually reverse timing signals;

the third drive signal and the second control signal are mutually reverse timing signals;

the second drive signal is a timing shift signal of the third drive signal;

the first control signal is a timing shift signal of the second control signal.

An embodiment of the present disclosure further discloses another driving method of a pixel circuit applied to the pixel circuit according to any of the above embodiments, the driving method including: in each working cycle,

in an initialization stage, connecting an initial power supply to the first initialization sub-circuit and the second initialization sub-circuit, and under the control of a second control signal and a second drive signal, turning on dual transistors of the first initialization sub-circuit and the second initialization sub-circuit, outputting an initial power supply potential Vinitial to the first terminal and the second terminal of the capacitor circuit, respectively, so that potentials of the first terminal and the second terminal of the capacitor circuit, and a gate potential of the drive transistor are Vinitial, wherein a gate-source voltage difference Vgs of the drive transistor is Vinitial-ELVDD, the ELVDD is the first power supply;

in a data writing stage, connecting written data to the data writing circuit, and under the control of a third drive signal and a second drive signal, turning on dual transistors of the data writing circuit to write the data to the first terminal of the capacitor circuit, and under the control of the third drive signal and the second drive signal, the compensation circuit turning on dual transistors of the compensation circuit, making a threshold voltage of the drive transistor compensated to the gate of the drive transistor so that the gate potential of the drive transistor is ELVDD+Vth, wherein the Vth is the threshold voltage of the drive transistor;

in a light emitting stage, under the control of a first control signal, the light emitting control circuit turning on a transistor of the light emitting control circuit, turning on a connection between the first power supply and the first electrode of the light emitting element, controlling the light emitting element to emit light, and under the control of the first control signal, the holding circuit outputting a potential Vref of a holding power supply to the first terminal of the capacitor circuit, and feeding back a difference between potentials of the first terminal of the capacitor circuit in the light emitting stage and in the data writing stage to the gate of the drive transistor so that the gate potential of the drive transistor is ELVDD+Vth+Vref−Vdata, wherein the gate-source voltage difference Vgs of the drive transistor is Vth+Vref−Vdata;

the second drive signal and the first control signal are mutually reverse timing signals;

the first drive signal, the second drive signal, and the third drive signal are timing signals that are shifted sequentially.

An embodiment of the present disclosure further discloses still another driving method of a pixel circuit applied to the pixel circuit according to any of the above embodiments, the driving method including: in each working cycle,

in an initialization stage, connecting an initial power supply to the first initialization sub-circuit and the second initialization sub-circuit, and under the control of a second control signal and a second drive signal, turning on dual transistors of the first initialization sub-circuit and the second initialization sub-circuit, outputting an initial power supply potential Vinitial to the first terminal and the second terminal of the capacitor circuit, respectively, so that potentials of the first terminal and the second terminal of the capacitor circuit, and a gate potential of the drive transistor are Vinitial, wherein a gate-source voltage difference Vgs of the drive transistor is Vinitial-ELVDD, the ELVDD is the first power supply;

in a data writing stage, connecting written data to the data writing circuit, and under the control of a third drive signal and a second drive signal, turning on dual transistors of the data writing circuit to write the data to the first terminal of the capacitor circuit, and under the control of the third drive signal and the second drive signal, the compensation circuit turning on dual transistors of the compensation circuit, making a threshold voltage of the drive transistor compensated to the gate of the drive transistor so that the gate potential of the drive transistor is ELVDD+Vth, wherein the Vth is the threshold voltage of the drive transistor;

in a light emitting stage, under the control of a first control signal, the light emitting control circuit turning on a transistor of the light emitting control circuit, turning on a connection between the first power supply and the first electrode of the light emitting element, controlling the light emitting element to emit light, and under the control of the first control signal, the holding circuit outputting a potential Vref of a holding power supply to the first terminal of the capacitor circuit, and feeding back a difference between potentials of the first terminal of the capacitor circuit in the light emitting stage and in the data writing stage to the gate of the drive transistor so that the gate potential of the drive transistor is ELVDD+Vth+Vref−Vdata, wherein the gate-source voltage difference Vgs of the drive transistor is Vth+Vref−Vdata;

the second drive signal and the first control signal are mutually reverse timing signals;

the third drive signal and the second control signal are mutually reverse timing signals;

the second drive signal is a timing shift signal of the third drive signal;

the first control signal is a timing shift signal of the second control signal.

### BRIEF DESCRIPTION OF THE DRAWINGS

By reading the detailed description of the non-limiting embodiments with reference to the following drawings, other features, objects and advantages of the present application will become more apparent.

FIG. 1 is a schematic diagram of a pixel circuit in the prior art;

FIG. 2 is a structural diagram of a pixel circuit according to an embodiment of the present application;

FIG. 3 is a structural diagram of a display device according to an embodiment of the present application;

FIG. 4 is a circuit diagram of a pixel circuit according to a first embodiment of the present application;

FIG. 5 is a signal timing diagram of the pixel circuit according to the first embodiment of the present application;

FIG. 6 is a working schematic diagram of an initialization stage of the pixel circuit according to the first embodiment of the present application;

FIG. 7 is a working schematic diagram of a data writing stage of the pixel circuit according to the first embodiment of the present application;

FIG. 8 is a working schematic diagram of a light emitting stage of the pixel circuit according to the first embodiment of the present application;

FIG. 9 is a circuit simulation diagram of the pixel circuit according to the first embodiment of the present application;

FIG. 10 is a circuit diagram of a pixel circuit according to a second embodiment of the present application;

FIG. 11 is a signal timing diagram of the pixel circuit according to the second embodiment of the present application;

FIG. 12 is a working schematic diagram of an initialization stage of the pixel circuit according to the second embodiment of the present application;

FIG. 13 is a working schematic diagram of a data writing stage of the pixel circuit according to the second embodiment of the present application;

FIG. 14 is a working schematic diagram of a light emitting stage of the pixel circuit according to the second embodiment of the present application;

FIG. 15 is a circuit simulation diagram of the pixel circuit according to the second embodiment of the present application;

FIG. 16 is a circuit diagram of a pixel circuit according to a third embodiment of the present application;

FIG. 17 is a signal timing diagram of the pixel circuit according to the third embodiment of the present application;

FIG. 18 is a working schematic diagram of an initialization stage of the pixel circuit according to the third embodiment of the present application;

FIG. 19 is a working schematic diagram of a data writing stage of the pixel circuit according to the third embodiment of the present application;

FIG. 20 is a working schematic diagram of a light emitting stage of the pixel circuit according to the third embodiment of the present application;

FIG. 21 is a circuit simulation diagram of the pixel circuit according to the third embodiment of the present application.

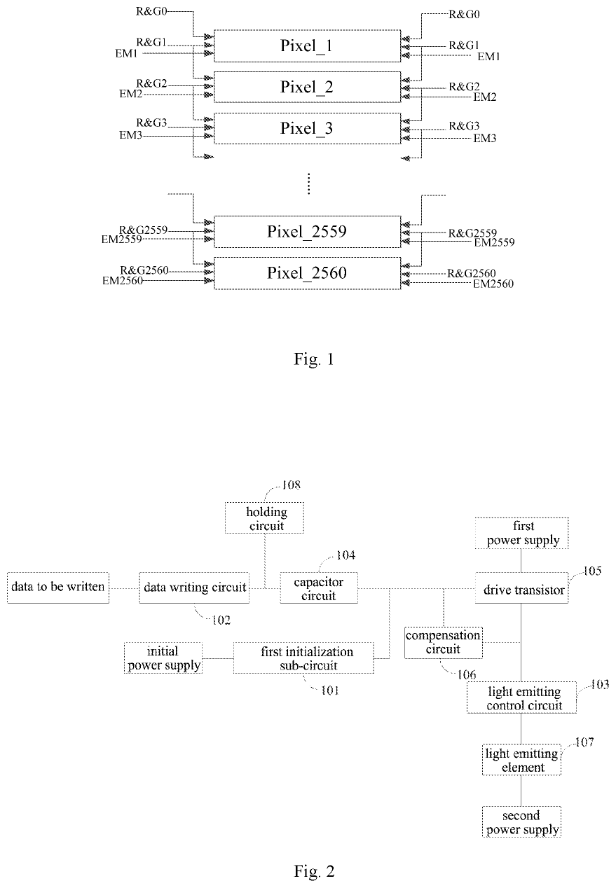

### DETAILED DESCRIPTION

The present disclosure will be further described hereinafter in details in conjunction with the drawings and the embodiments. It will be understood that the specific embodiment described herein is merely an illustration of the present disclosure rather than a limitation thereof. In addition, it should be noted that, for ease of description, only the parts related to the present disclosure are shown in the drawings.

It should be noted that the embodiments in the present application and the features in the embodiments can be combined with each other if there is no conflict. Hereinafter, the present application will be described in detail with reference to the drawings and in conjunction with the embodiments.

The transistors in the embodiments are based on P-type transistors. The driving terminal of a P-type transistor is active low and inactive high. Accordingly, through the embodiments of this application, those skilled in the art can also obtain a technical solution having the technical effect of this application by using N-type transistors. The embodiments of this application only use the P-type transistor as an example, and does not discuss the technical solution of N-type transistor.

As shown in FIG. 2, in FIG. 2:

ELVDD represents a first power supply; ELVSS represents a second power supply; Vref is a holding power supply; Vinitial is an initial power supply; Data is written data.

The Pixel Circuit Includes:

a first initialization sub-circuit 101, a data writing circuit 102, a light emitting control circuit 103, a capacitor circuit 104, a drive transistor 105, a compensation circuit 106, a light emitting element 107, and a holding circuit 108;

the first initialization sub-circuit 101 is connected to a second terminal of the capacitor circuit 104 and a gate of the drive transistor 105; when the transistor of the first initialization sub-circuit 101 is turned on, the first initialization sub-circuit 101 receives an output potential of an initial power supply, outputs the output potential of the initial power supply to the gate of the drive transistor 105, and is configured to complete initialization of the drive transistor 105;

the data writing circuit 102 is connected to a first terminal of the capacitor circuit 104; when the transistor of the data writing circuit 102 is turned on, data to be written is written to the capacitor circuit 104 by the data writing circuit 102; the data writing circuit 102 is configured to, in a data writing stage, cause the capacitor circuit 104 to store data to be written to the gate of the drive transistor 105;

the light emitting control circuit 103 is connected to a first electrode of the light emitting element 107 and a second electrode of the drive transistor 105; in a light emitting stage, when the transistor of the light emitting control circuit 103 is turned on, the drive transistor 105 and the light emitting control circuit 103 control the potentials of a first power supply and a second power supply to be respectively output to the first electrode of the light emitting element 107 to cause the light emitting element 107 to emit light;

the holding circuit 108 is connected to the first terminal of the capacitor circuit 104, and is configured to stabilize a gate potential of the drive transistor 105;

a first electrode of the drive transistor 105 is connected to the first power supply, and the second electrode of the drive transistor 105 is connected to the light emitting control circuit 103;

the compensation circuit 106 is connected to the second electrode and the gate of the drive transistor 105, and is configured to perform potential compensation on the gate of the drive transistor 105 when the data writing circuit 102 writes data to the first terminal of the capacitor circuit 104;

Specifically, after the first initialization sub-circuit 101 completes the initialization of the gate of the drive transistor 105, the gate potential of the drive transistor 105 is Vinitial, so that the gate-source potential difference Vgs of the drive transistor 105 is Vinitial-ELVDD; after being compensated by the compensation circuit 106, the gate potential of the drive transistor 105 is ELVDD+Vth, wherein the Vth is the threshold voltage of the drive transistor 105; that is, the compensation circuit 106 causes the threshold voltage of the drive transistor 105 to be compensated to the gate of the drive transistor 105.

a second electrode of the light emitting element 107 is connected to a second power supply; when the drive transistor 105 and the transistor in the light emitting control circuit 103 are turned on, the first power source and the second power source are connected to the first electrode and the second electrode of the light emitting element 107, respectively, so that the light emitting element 107 emits light. The circuit at this time is also a dual-transistor circuit;

the holding circuit 108 is connected to the first terminal of the capacitor circuit 104, and is configured to hold the working state of the circuit before the first initialization sub-circuit 101 initializes the drive transistor 105;

the first initialization sub-circuit 101 and the compensation circuit 106 are dual-transistor circuits, the dual-transistor circuit can effectively reduce the leakage of the first terminal and the second terminal of the capacitor circuit 104, and improve the potential stability of the first terminal and the second terminal of the capacitor circuit 104. Wherein, a transistor in the first initialization sub-circuit 101 is also multiplexed as a transistor in the compensation circuit. Transistor multiplexing can effectively reduce the number of transistors and achieve the target of simplifying the circuit.

For example, if transistor multiplexing is not used, the first initialization sub-circuit 101 has dual transistors, and the compensation circuit 106 also has dual transistors. This requires four transistors and the circuit is more complicated. Through transistor multiplexing, it is reduced to three transistors, and the number of transistors is significantly reduced.

In the present application, through the first initialization sub-circuit, the data writing circuit, the light emitting control circuit, the capacitor circuit, the compensation circuit, and the drive transistor, in the initialization stage, the potential of the initial power supply is sent to the gate of the drive transistor so that the initialization of the circuit is completed, in the data writing stage, data is written to the gate of the drive transistor, and in the light emitting stage, the light emitting control circuit controls the light emitting element to emit light, which combines light emitting control driving with gate driving, and can eliminate short-term image sticking, reduce leakage through dual transistor layout, and reduce the number of transistors through transistor multiplexing.

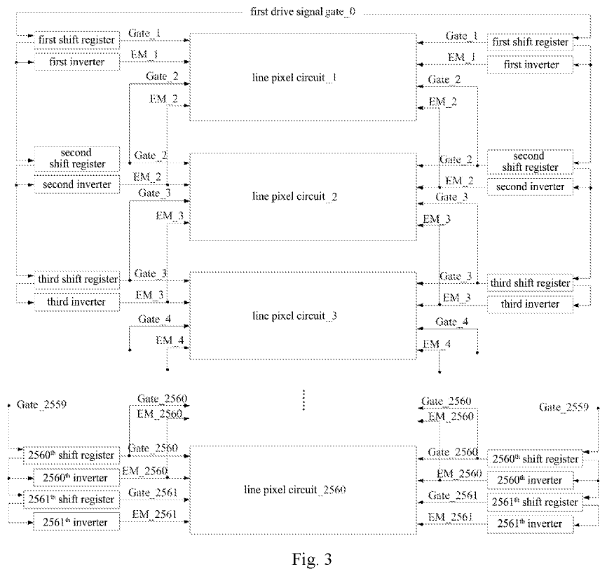

As shown in FIG. 3, the present application discloses a display device which includes the pixel circuit provided by any of the embodiments of the present application. The display device includes multiple pixel circuits arranged in an array, the multiple pixel circuits are divided into multiple lines of pixel circuits; the display device further includes a gate driver circuit, a light emitting signal control circuit, and a first drive signal;

the gate driver circuit includes a first shift register unit and a second shift register unit;

the first shift register unit and the second shift register unit are configured to output an input timing signal as a timing signal shifted by one bit, the first shift register unit input the output timing signal into the second shift register unit;

the light emitting signal control circuit includes a first inverter unit and a second inverter unit;

the first inverter unit receives the timing signal output by the first shift register unit, and inverts the timing signal output by the first shift register unit, the second inverter unit receives the timing signal output by the second shift register unit, and inverts the timing signal output by the second shift register unit;

the first drive signal is input to the first shift register unit;

the first shift register unit, the second shift register unit, the timing signals output by the first shift register unit and the second shift register unit are output to each line of the pixel circuit to realize works of an initialization stage, a data writing stage and a light emitting stage of each line of the pixel circuit.

It can be understood that, for the drive mode of the line pixel circuit, it may be one-end driving or both-end driving. It may be that one line pixel circuit is driven at both ends, or may be that odd-numbered lines of line pixel circuits are driven at one end, and even-numbered lines of line pixel circuits are driven at the other end. For multiple line pixel circuits in the pixel circuit, they may be driven line by line or interlaced. These different drive modes are only related to the order of the input and output signals of the relevant shift registers and inverters, they are consistent with the driving principle of this embodiment, and will not be repeated in this application.

In practical applications, multiple shift registers and multiple inverters can be provided. The multiple shift registers and multiple inverters can be provided in cascade with each other. For example, the output signal timing of the first shift register is used as the input signal timing of the second shift register, or the output signal timing of the first shift register is used as the input signal timing of the third shift register. The specific cascade mode is related to the specific display mode of the line pixels required by the pixel circuit of the present application. For example, in line-by-line display, the output signal timing of the first shift register is used as the input signal timing of the second shift register; in interlaced display, the output signal timing of the first shift register is used as the input signal timing of the third shift register; when displaying every two lines, the output signal timing of the first shift register is used as the input signal timing of the fourth shift register; and so on. In particular, the embodiment of FIG. 3 in this application is a specific driving method for driving multiple line pixel circuits in the line-by-line manner. For other driving methods, the input signal timing of the shift register can be output to the corresponding line pixel circuit to drive the various working stages of the line pixel circuit according to actual needs by referring to the method of the embodiment shown in FIG. 3.

In the embodiment of the present disclosure, the second drive signal and the first control signal are mutually reverse timing signals;

the third drive signal and the second control signal are mutually reverse timing signals;

the first drive signal, the second drive signal, and the third drive signal are timing signals that are shifted sequentially;

the first control signal is a timing shift signal of the second control signal.

### Embodiment I

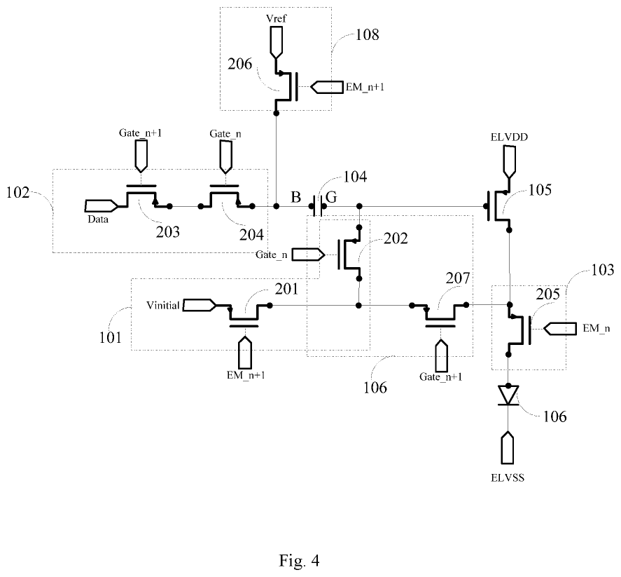

As shown in FIG. 4, in FIG. 4, ELVDD represents a first power supply; ELVSS represents a second power supply; Gate_n is a second drive signal; Gate_n+1 is a third drive signal; EM_n is a first control signal; EM_n+1 is a second control signal; Vref is a holding power supply; Vinitial is an initial power supply; Data is written data. It should be noted that the above English abbreviations or letter pronouns is only used in the drawings to represent the corresponding Chinese characters. In the description of the following embodiment, the Chinese characters are still used.

The first initialization sub-circuit 101 includes a first transistor 201 and a second transistor 202;

a first electrode of the first transistor 201 is connected to the initial power supply;

a second electrode of the first transistor 201 is connected to a second electrode of the second transistor 202, a first electrode of the second transistor 202 is connected to the gate of the drive transistor 105;

the first transistor 210 outputs the potential of the initial power supply to the second electrode of the second transistor 202 in response to the second control signal; the second transistor 202 outputs the potential of the initial power supply to the gate of the drive transistor 105 in response to the second drive signal.

The data writing circuit 102 includes a third transistor 203 and a fourth transistor 204;

the fourth transistor 204 is a transistor that is multiplexed by the data writing circuit 102 and the second initialization sub-circuit 109;

a second electrode of the third transistor 203 is connected to the written data;

a first electrode of the third transistor 203 is connected to a second electrode of the fourth transistor 204, a first electrode of the fourth transistor 204 is connected to the first terminal of the capacitor circuit 104;

the third transistor 203 writes the written data to the second electrode of the fourth transistor 204 in response to the third drive signal; the fourth transistor 204 writes the written data to the first terminal of the capacitor circuit 104 in response to the second drive signal.

The light emitting control circuit 103 includes a fifth transistor 205;

a first electrode of the fifth transistor 205 is connected to the second electrode of the drive transistor 105, a second electrode of the fifth transistor 205 is connected to the first electrode of the light emitting element 107;

the fifth transistor 205 outputs a potential of the first power supply passing through the drive transistor 105 to the first electrode of the light emitting element 107 in response to the first control signal.

The compensation circuit 106 includes a second transistor 202 and a seventh transistor 207;

the second transistor 202 is a transistor that is multiplexed by the compensation circuit 106 and the first initialization sub-circuit 101;

a first electrode of the second transistor 202 is connected to the gate of the drive transistor 105, a second electrode of the second transistor 202 is connected to a first electrode of the seventh transistor 207;

a second electrode of the seventh transistor 207 is connected to the second electrode of the drive transistor 105;

the seventh transistor 207, in response to the third drive signal, causes a threshold voltage of the drive transistor 105 to be compensated to the gate of the drive transistor 105 via the second transistor 202;

the holding circuit 108 includes a sixth transistor 206, a first electrode of the sixth transistor 206 is connected to the holding power supply, a second electrode of the sixth transistor 206 is connected to the first terminal of the capacitor circuit 104;

the sixth transistor 206 outputs the potential of the holding power supply to the first terminal of the capacitor circuit 104 in response to the second control signal.

FIGS. 6 to 8 illustrate that, in the initialization stage, the data writing stage, and the light emitting stage, under the control of the second drive signal Gate_n, the third drive signal Gate_n+1, the first control signal EM_n, and the second control signal EM_n+1, the pixel circuit achieves turning on and turning off of corresponding transistors, avoiding the abnormal light emission of the light emitting element 107, eliminating the short-term image sticking of the circuit, reducing the leakage and reducing the number of transistors.

As shown in FIGS. 6 to 8, the first transistor and the sixth transistor are controlled by the second control signal; the fifth transistor is controlled by the first control signal; the fourth transistor and the second transistor are controlled by the second drive signal. The third transistor and the seventh transistor are controlled by the third drive signal.

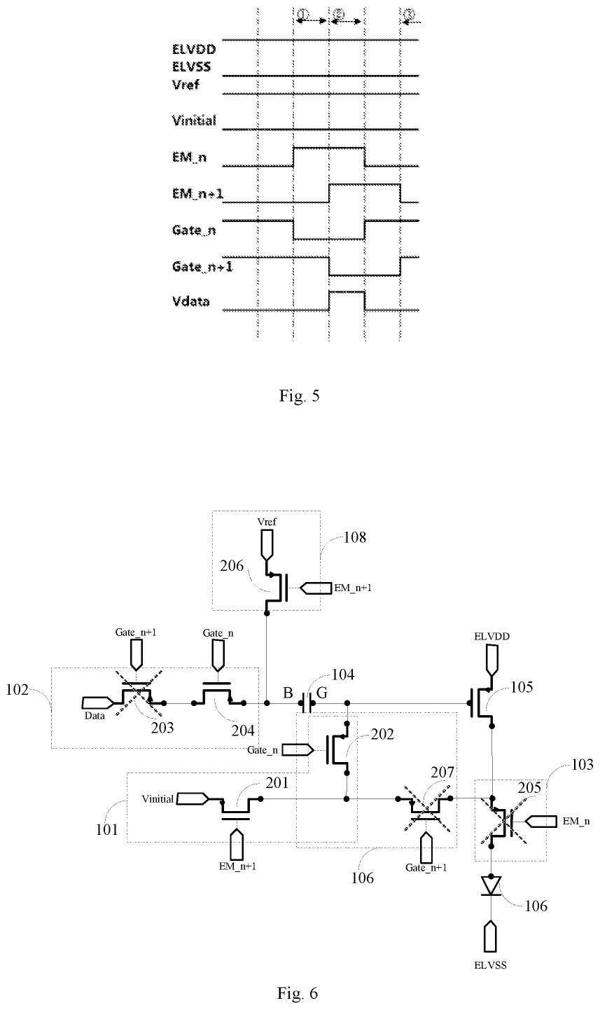

As shown in FIG. 5, the signal timing of the second drive signal is reversed from the signal timing of the first control signal, and the signal timing of the third drive signal is reversed from the signal timing of the second control signal, the third drive signal is a shift signal of the second drive signal, the second control signal is a shift signal of the first control signal.

In order to determine the leakage of the circuit, the first terminal and the second terminal of the capacitor circuit 104 are used as a node “B” and a node “G” for detecting the potential parameter, respectively.

The Specific Workflow is as Follows:

The first stage is the initialization stage, as shown in FIGS. 5 and 6.

At this time, the first control signal is at a high level, the second control signal is at a low level, the second drive signal is at a low level, the third drive signal is at a high level, and the second control signal and the second drive signal are effective. At this time, the initial power supply is connected to the first initialization sub-circuit 101. Since the sixth transistor 206, the first transistor 201, the fourth transistor 204, and the second transistor 202 are turned on, and the third transistor 203, the fifth transistor 205, and the seventh transistor 207 are turned off, the initial power potential Vinitial is written to the node “G”, so that the gate-source potential difference Vgs of the drive transistor 105 is Vinitial-ELVDD, and at the same time the node “B” at the first terminal of the capacitor circuit 104 maintains the write potential at the potential Vref of the holding power supply, preventing a floating potential at both ends of the capacitor circuit 104 (which will cause the gate potential of the drive transistor 105 to be unstable). At this time, the initialization of the drive transistor 105 is completed.

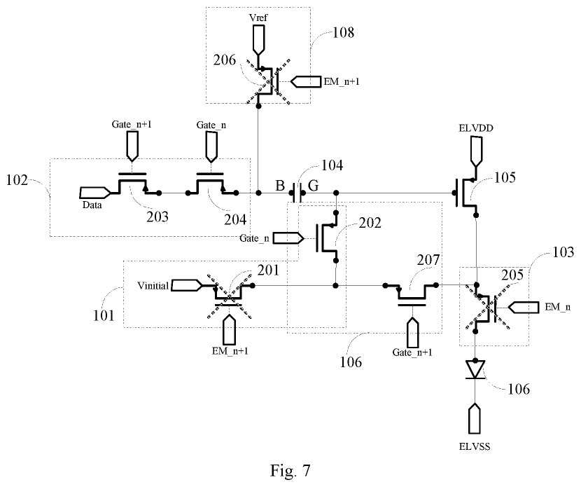

The second stage is the writing data stage, as shown in FIGS. 5 and 7.

At this time, the first control signal and the second control signal are at a high level, the second drive signal and the third drive signal are at a low level, and the second drive signal and the third drive signal are effective. At this time, the written data is connected to the data writing circuit 102, the second transistor 202, the third transistor 203, the fourth transistor 204, and the seventh transistor 207 are turned on, and the first transistor 201, the fifth transistor 205, and the six transistor 206 are turned off, and the write potential of the node “G” at the second terminal of the capacitor circuit 104 is ELVDD+Vth, that is, the gate potential of the drive transistor 105 is ELVDD+Vth, wherein the Vth is the threshold potential of the drive transistor 105. In other words, the compensation circuit 106 causes the threshold voltage of the drive transistor 105 to be compensated to the gate of the drive transistor 105. Since the third transistor 203 and the fourth transistor 204 are turned on, the potential of the node “B” is the potential Vdata of the written data.

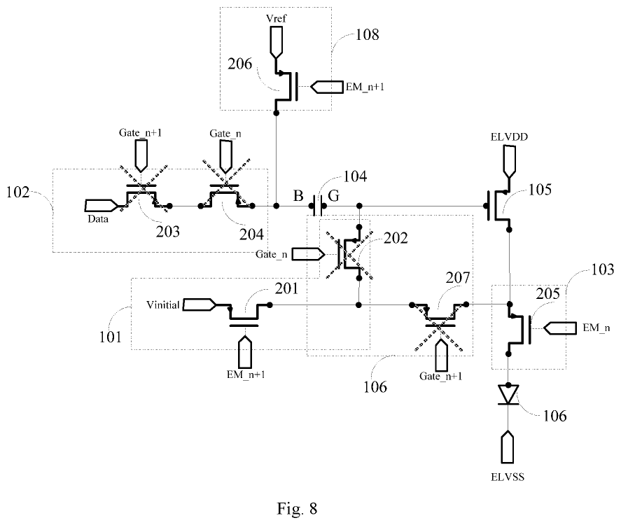

The third stage is the light emitting stage, as shown in FIGS. 5 and 8.

At this time, the first control signal and the second control signal are at a low level, the second drive signal and the third drive signal are at a high level, and the first control signal and the second control signal are effective. At this time, first transistor 201, the fifth transistor 205 and the sixth transistor 206 are turned on. Since the second transistor 202 is turned off at this time, neither the first initialization sub-circuit 101 nor the compensation circuit 106 work, and the potential of the node “B” at the first terminal of the capacitor circuit 104 becomes the potential Vref of the holding power supply. At this time, the potential of the node “B” at the first terminal of the capacitor circuit 104 changes from Vdata to Vref, and the amount of its potential change is Vref-Vdata. The amount of its potential change is fed back to the node “G” at the second terminal of the capacitor circuit 104 to make the potential of the node “G” become ELVDD+Vth+Vref-−data, and thus the gate-source potential difference Vgs of the drive transistor 105 is Vgs=Vth+Vref-Vdata; since the fifth transistor 205 is turned on, a current is formed between the first electrode and the second electrode of the light emitting element 106, and the current is I=K (Vref-Vdata)², wherein K is a coefficient. It can be seen that the current between the first electrode and the second electrode of the light emitting element 106 has no relation to the threshold potential Vth of the drive transistor 105.

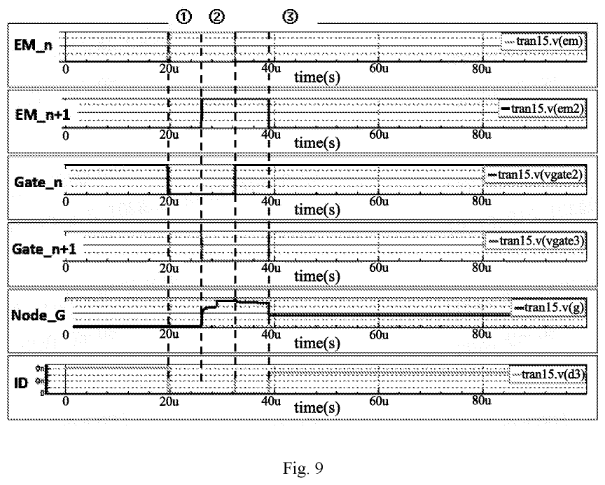

FIG. 9 is a circuit simulation diagram of the present embodiment. It can be seen from FIG. 9 that the potential and current of the node “G” at the second terminal of the capacitor circuit 104 are stable.

### Embodiment II

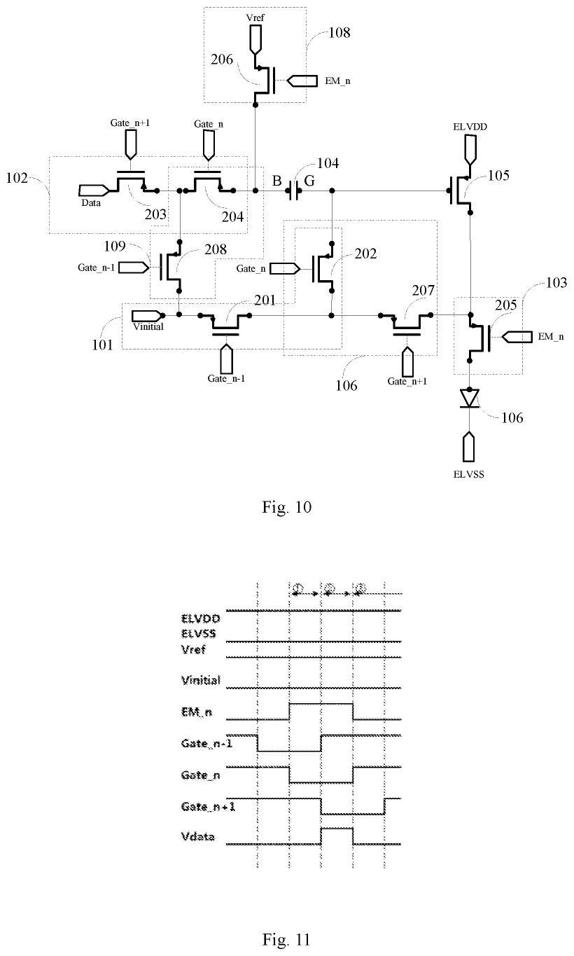

As shown in FIG. 10, in FIG. 10, ELVDD represents a first power supply; ELVSS represents a second power supply; Gate_n−1 is a first drive signal; Gate_n is a second drive signal; Gate_n+1 is a third drive signal; EM_n is a first control signal; Vref is a holding power supply; Vinitial is an initial power supply; Data is written data. It should be noted that the above English abbreviations or letter pronouns is only used in the drawings to represent the corresponding Chinese characters. In the following description, the Chinese characters are still used.

The first initialization sub-circuit 101 includes the first transistor 201 and the second transistor 202;

the first electrode of the first transistor 201 is connected to an initial power supply;

the second electrode of the first transistor 201 is connected to the second electrode of the second transistor 202, the first electrode of the second transistor 202 is connected to the gate of the drive transistor 105;

the first transistor 210 outputs the potential of the initial power supply to the second electrode of the second transistor 202 in response to the first drive signal; the second transistor 202 outputs the potential of the initial power supply to the gate of the drive transistor 105 in response to the second drive signal.

The data writing circuit 102 includes the third transistor 203 and the fourth transistor 204;

the fourth transistor 204 is a transistor that is multiplexed by the data writing circuit 102 and the second initialization sub-circuit 109;

the second electrode of the third transistor 203 is connected to the written data;

the first electrode of the third transistor 203 is connected to the second electrode of the fourth transistor 204, the first electrode of the fourth transistor 204 is connected to the first terminal of the capacitor circuit 104;

the third transistor 203 writes the written data to the second electrode of the fourth transistor 204 in response to the third drive signal; the fourth transistor 204 writes the written data to the first terminal of the capacitor circuit 104 in response to the second drive signal.

The light emitting control circuit 103 includes the fifth transistor 205;

the first electrode of the fifth transistor 205 is connected to the second electrode of the drive transistor 105, the second electrode of the fifth transistor 205 is connected to the first electrode of the light emitting element 107;

the fifth transistor 205 outputs the potential of the first power supply passing through the drive transistor 105 to the first electrode of the light emitting element 107 in response to the first control signal.

The compensation circuit 106 includes the second transistor 202 and the seventh transistor 207;

the second transistor 202 is a transistor that is multiplexed by the compensation circuit 106 and the first initialization sub-circuit 101;

the first electrode of the second transistor 202 is connected to the gate of the drive transistor 105, the second electrode of the second transistor 202 is connected to the first electrode of the seventh transistor 207;

the second electrode of the seventh transistor 207 is connected to the second electrode of the drive transistor 105;

the seventh transistor 207, in response to the third drive signal, causes the threshold voltage of the drive transistor 105 to be compensated to the gate of the drive transistor 105 via the second transistor 202;

the holding circuit 108 includes the sixth transistor 206, the first electrode of the sixth transistor 206 is connected to the holding power supply, the second electrode of the sixth transistor 206 is connected to the first terminal of the capacitor circuit 104;

the sixth transistor 206 outputs the potential of the holding power supply to the first terminal of the capacitor circuit 104 in response to the first control signal.

The circuit further includes the second initialization sub-circuit 109;

the second initialization sub-circuit 109 is connected to the first terminal of the capacitor circuit 104, and is configured to complete initialization of the capacitor circuit 104; during the initialization process, the transistor of the second initialization sub-circuit 109 is turned on, and the initial power supply is output to the first terminal of the capacitor circuit 104 via the second initialization sub-circuit 109. Combined with the first initialization sub-circuit 101, after the initialization, both the potentials of the first terminal and the second terminal of the capacitor circuit 104 are the potential Vinitial of the initial power supply.

The data writing circuit 102 and the second initialization sub-circuit 109 are dual-transistor circuits, the dual-transistor structure of the second initialization sub-circuit 109 reduces the leakage of the first terminal of the capacitor circuit 104, wherein, a transistor in the second initialization sub-circuit 109 is also multiplexed as a transistor in the data writing circuit 102. Through transistor multiplexing, the number of transistors is reduced. For example, if transistor multiplexing is not used, the second initialization sub-circuit 109 has dual transistors, and the data writing circuit 102 also has dual transistors. This requires four transistors and the circuit is more complicated. Through transistor multiplexing, it is reduced to three transistors, and the number of transistors is significantly reduced.

The second initialization sub-circuit 109 includes the fourth transistor 204 and an eighth transistor 208;

the second electrode of the eighth transistor 208 is connected to the initial power supply;

the first electrode of the eighth transistor 208 is connected to the second electrode of the fourth transistor 204, the first electrode of the fourth transistor 204 is connected to the first terminal of the capacitor circuit 104;

the eighth transistor 208 outputs the potential of the initial power supply to the second electrode of the fourth transistor 204 in response to the first drive signal;

the fourth transistor 204 outputs the potential of the initial power supply to the first terminal of the capacitor circuit 104 in response to the second drive signal.

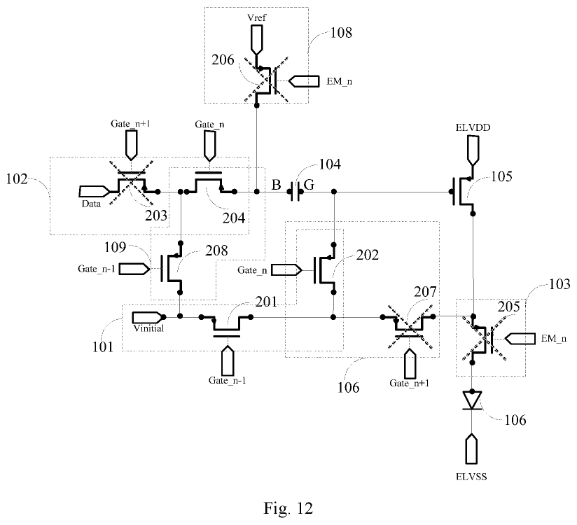

FIGS. 12 to 14 illustrate that, in the initialization stage, the data writing stage, and the light emitting stage, under the control of the first drive signal Gate_n−1, the second drive signal Gate_n, the third drive signal Gate_n+1, and the first control signal EM_n, the pixel circuit achieves turning on and turning off of corresponding transistors, avoiding the abnormal light emission of the light emitting element 107, eliminating the short-term image sticking of the circuit, reducing the leakage and reducing the number of transistors.

As shown in FIGS. 12 to 14, the first transistor 201 and the eighth transistor 208 are controlled by the first drive signal; the fourth transistor 204 and the second transistor 202 are controlled by the second drive signal; the three transistor 203 and the seventh transistor 207 are controlled by the third drive signal; the fifth transistor 205 and the sixth transistor 206 are controlled by the first control signal.

As shown in FIG. 11, the signal timing of the second drive signal is reversed from the signal timing of the first control signal, the third drive signal, the second drive signal and the first drive signal are shift signals that are shifted sequentially.

The Specific Workflow is as Follows:

The first stage is the initialization stage, as shown in FIGS. 11 and 12.

At this time, the first drive signal and the second drive signal are at a low level, the third drive signal is at a high level; the first control signal is at a high level. Since the first drive signal and the second drive signal are effective, the first transistor 201, the second transistor 202, the eighth transistor 208, and the fourth transistor 204 are driven to be turned on. At this time, the first initialization sub-circuit 101 and the second initialization sub-circuit 109 start to work, and outputs the potential Vinitial of the initial power supply to the first terminal and the second terminal of the capacitor circuit, respectively; the potential Vinitial of the initial power supply is written to the node “G” at the second terminal and the node “B” at the first terminal of the capacitor circuit 104. The gate potential of the drive transistor 105 is also Vinitial. Both terminals of the capacitor circuit 104 are not floating, and the gate potential of the drive transistor 105 is stable. At this time, the initialization of the drive transistor 105 is completed. At this time, the gate-source potential difference Vgs of the drive transistor 105 is a fixed value: Vgs=Vinitial-ELVDD, that is, the potential Vinitial of the initial power supply at the gate of the drive transistor 105 minus the potential ELVDD of the first power supply at the source. Since for each frame of image, the gate-source potential difference Vgs of the drive transistor 105 is at this value in the initialization stage, the short-term image sticking can be alleviated. At this time, since the first control signal is at a high level and the fifth transistor 205 is not turned on, the light emitting display cannot be performed.

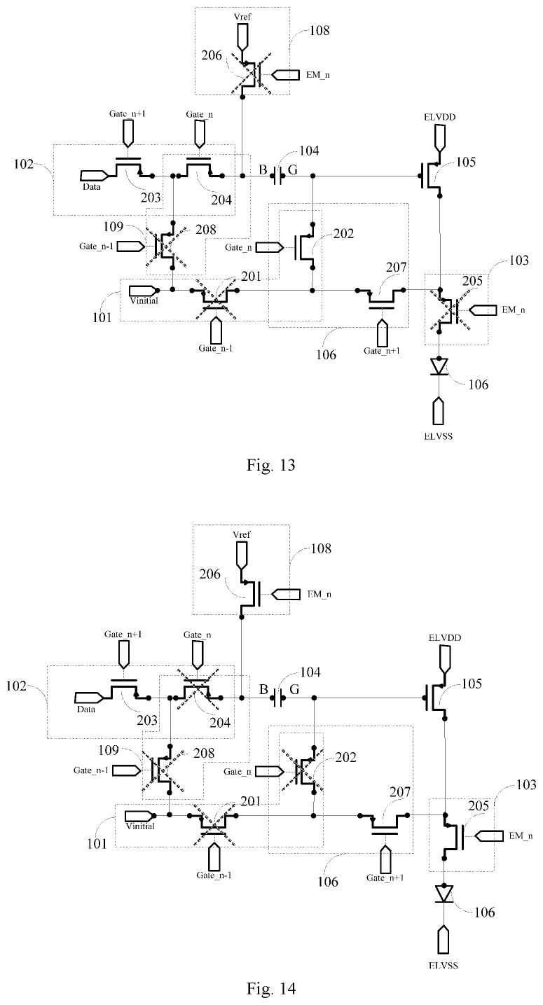

The second stage is the writing data stage, as shown in FIGS. 11 and 13.

At this time, the second drive signal and the third drive signal are at low level, the first drive signal is at high level, the first control signal is at high level, and the second drive signal and third drive signal are effective, and thus the third transistor 203 and the fourth transistor 204 are driven to be turned on, that is, the data writing circuit 102 starts to work. Since the gate-source potential difference Vgs of the drive transistor 105 is less than Vth in the initialization stage, wherein the Vth is the threshold voltage of the drive transistor 105, the potential ELVDD of the first power supply input to the first electrode of the light emitting element 106 is written to the node “G” until the potential of the node “G” is ELVDD+Vth, that is, the compensation circuit 106 causes the threshold voltage of the drive transistor 105 to be compensated to the gate of the drive transistor 105. Since the third transistor 203 and the fourth transistor 204 are turned on, the data writing circuit 102 writes the written data Vdata to the node “B”.

The third stage is the light emitting stage, as shown in FIGS. 11 and 14.

At this time, the first drive signal and the second drive signal are at high level, the third drive signal is at low level, the first control signal is at low level, and thus the third drive signal and the first control signal are effective. At this time, the fifth transistor 205 is turned on, and the potential of the node “B” at the first terminal of the capacitor circuit 104 becomes the potential Vref of the holding power supply. At this time, the potential of the node “B” at the first terminal of the capacitor circuit 104 changes from Vdata to Vref, and the amount of its potential change is Vref-Vdata. The amount of its potential change is fed back to the node “G” at the second terminal of the capacitor circuit 104 to make the potential of the node “G” become ELVDD+Vth+Vref−Vdata, and thus the gate-source potential difference Vgs of the drive transistor 105 is Vgs=Vth+Vref−Vdata; since the fifth transistor 205 is turned on at this time, a current is formed between the first electrode and the second electrode of the light emitting element 106, and the current is I=K (Vref-Vdata)², wherein K is a coefficient. It can be seen that the current between the first electrode and the second electrode of the light emitting element 106 has no relation to the threshold potential Vth of the drive transistor 105.

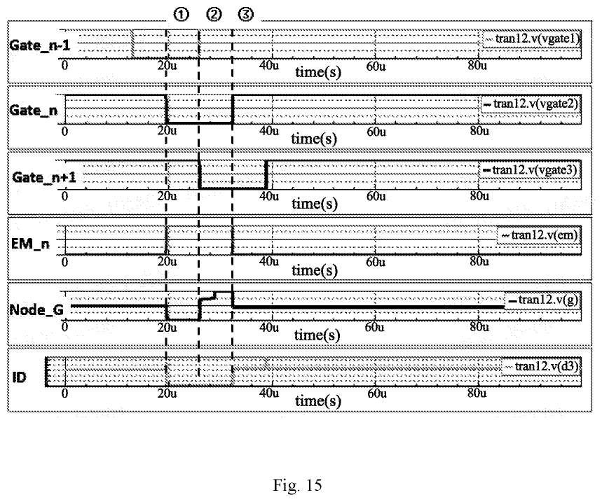

FIG. 15 is a circuit simulation diagram of the present embodiment. It can be seen from FIG. 15 that the potential and current of the node “G” at the second terminal of the capacitor circuit 104 are stable.

### Embodiment III

The first initialization sub-circuit 101 includes the first transistor 201 and the second transistor 202;

the first electrode of the first transistor 201 is connected to the initial power supply;

the second electrode of the first transistor 201 is connected to the second electrode of the second transistor 202, the first electrode of the second transistor 202 is connected to the gate of the drive transistor 105;

the first transistor 210 outputs the potential of the initial power supply to the second electrode of the second transistor 202 in response to the second control signal; the second transistor 202 outputs the potential of the initial power supply to the gate of the drive transistor 105 in response to the second drive signal.

The data writing circuit 102 includes the third transistor 203 and the fourth transistor 204;

the fourth transistor 204 is a transistor that is multiplexed by the data writing circuit 102 and the second initialization sub-circuit 109;

the second electrode of the third transistor 203 is connected to the written data;

the first electrode of the third transistor 203 is connected to the second electrode of the fourth transistor 204, the first electrode of the fourth transistor 204 is connected to the first terminal of the capacitor circuit 104;

the third transistor 203 writes the written data to the second electrode of the fourth transistor 204 in response to the third drive signal; the fourth transistor 204 writes the written data to the first terminal of the capacitor circuit 104 in response to the second drive signal.

The light emitting control circuit 103 includes the fifth transistor 205;

the first electrode of the fifth transistor 205 is connected to the second electrode of the drive transistor 105, the second electrode of the fifth transistor 205 is connected to the first electrode of the light emitting element 107;

the fifth transistor 205 outputs the potential of the first power supply passing through the drive transistor 105 to the first electrode of the light emitting element 107 in response to the first control signal.

The compensation circuit 106 includes the second transistor 202 and the seventh transistor 207;

the second transistor 202 is a transistor that is multiplexed by the compensation circuit 106 and the first initialization sub-circuit 101;

the first electrode of the second transistor 202 is connected to the gate of the drive transistor 105, the second electrode of the second transistor 202 is connected to the first electrode of the seventh transistor 207;

the second electrode of the seventh transistor 207 is connected to the second electrode of the drive transistor 105;

the seventh transistor 207, in response to the third drive signal, causes the threshold voltage of the drive transistor 105 to be compensated to the gate of the drive transistor 105 via the second transistor 202;

the holding circuit 108 includes the sixth transistor 206, the first electrode of the sixth transistor 206 is connected to the holding power supply, the second electrode of the sixth transistor 206 is connected to the first terminal of the capacitor circuit 104;

the sixth transistor 206 outputs the potential of the holding power supply to the first terminal of the capacitor circuit 104 in response to the first control signal.

The circuit further includes the second initialization sub-circuit 109;

the second initialization sub-circuit 109 is connected to the first terminal of the capacitor circuit 104, and is configured to complete initialization of the capacitor circuit 104; during the initialization process, the transistor of the second initialization sub-circuit 109 is turned on, and the initial power supply is output to the first terminal of the capacitor circuit 104 via the second initialization sub-circuit 109. Combined with the first initialization sub-circuit 101, after the initialization, both the potentials of the first terminal and the second terminal of the capacitor circuit 104 are the potential Vinitial of the initial power supply.

The second initialization sub-circuit 109 is a dual-transistor circuit, the dual-transistor structure of the second initialization sub-circuit 109 reduces the leakage of the first terminal of the capacitor circuit 104, wherein, a transistor in the second initialization sub-circuit 109 is also multiplexed as a transistor in the data writing circuit 102. Through transistor multiplexing, the number of transistors is reduced. For example, if transistor multiplexing is not used, the second initialization sub-circuit 109 has dual transistors, and the data writing circuit 102 also has dual transistors. This requires four transistors and the circuit is more complicated. Through transistor multiplexing, it is reduced to three transistors, and the number of transistors is significantly reduced.

The second initialization sub-circuit 109 includes the fourth transistor 204 and an eighth transistor 208;

the second electrode of the eighth transistor 208 is connected to the initial power supply;

the first electrode of the eighth transistor 208 is connected to the second electrode of the fourth transistor 204, the first electrode of the fourth transistor 204 is connected to the first terminal of the capacitor circuit 104;

the eighth transistor 208 outputs the potential of the initial power supply to the second electrode of the fourth transistor 204 in response to the second control signal;

the fourth transistor 204 outputs the potential of the initial power supply to the first terminal of the capacitor circuit 104 in response to the second drive signal.

FIGS. 17 to 19 illustrate that, in the initialization stage, the data writing stage, and the light emitting stage, under the control of the second drive signal Gate_n, the third drive signal Gate_n+1, the first control signal EM_n, and the second control signal EM_n+1, the pixel circuit achieves turning on and turning off of corresponding transistors, avoiding the abnormal light emission of the light emitting element 107, eliminating the short-term image sticking of the circuit, reducing the leakage and reducing the number of transistors.

As shown in FIGS. 17 to 19, the first transistor 201 and the eighth transistor 208 are controlled by the second control signal; the fourth transistor 204 and the second transistor 202 are controlled by the second drive signal; the three transistors 203 and the seventh transistor 207 are controlled by the third drive signal; the fifth transistor 205 and the sixth transistor 206 are controlled by the first control signal.

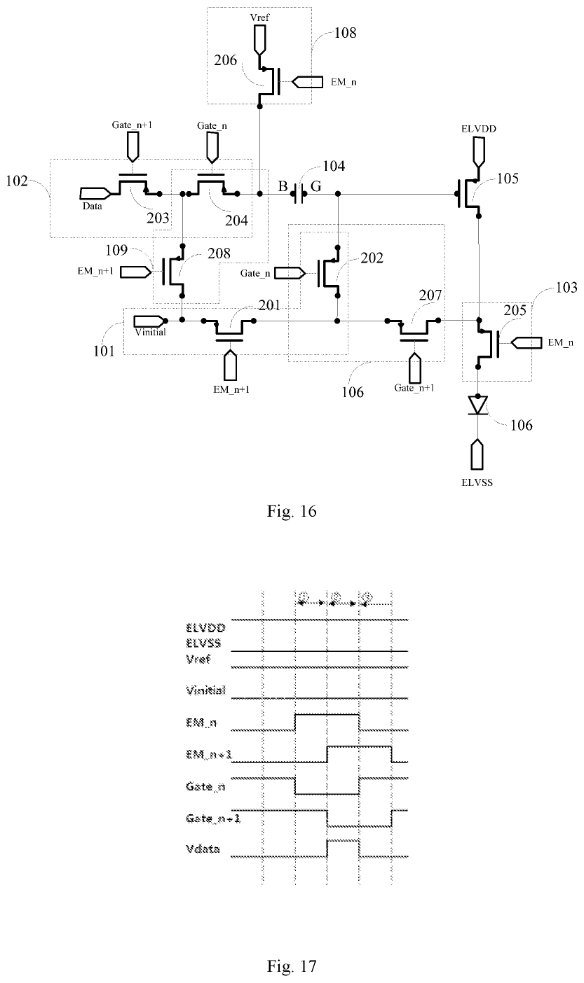

As shown in FIG. 16, the signal timing of the second drive signal is reversed from the signal timing of the first control signal, and the signal timing of the third drive signal is reversed from the signal timing of the second control signal, the third drive signal is a shift signal of the second drive signal, the second control signal is a shift signal of the first control signal.

In order to determine the leakage of the circuit, the first terminal and the second terminal of the capacitor circuit 104 are used as a node “B” and a node “G” for detecting the potential parameter, respectively.

The Specific Workflow is as Follows:

The first stage is the initialization stage, as shown in FIGS. 16 and 17.

At this time, the second control signal and the second drive signal are at a low level, the second drive signal is at a low level, the third drive signal is at a high level; the first control signal is at a high level. Since the second control signal and the second drive signal are effective, the first transistor 201, the second transistor 202, the eighth transistor 208, and the fourth transistor 204 are driven to be turned on. At this time, the first initialization sub-circuit 101 and the second initialization sub-circuit 109 start to work, and output the potential Vinitial of the initial power supply to the first terminal and the second terminal of the capacitor circuit, respectively. The potential Vinitial of the initial power supply is written to the node “G” at the second terminal and the node “B” at the first terminal of the capacitor circuit 104. The gate potential of the drive transistor 105 is also Vinitial. Since the potentials of both the two terminals of the capacitor circuit 104 are Vinitial, the gate voltage of the drive transistor 105 is stable, and the initialization of the drive transistor 105 is completed. At this time, the gate-source potential difference Vgs of the drive transistor 105 is a fixed value: Vgs=Vinitial-ELVDD, that is, the potential Vinitial of the initial power supply at the gate of the drive transistor 105 minus the potential ELVDD of the first power supply at the source. Since for each frame of image, the gate-source potential difference Vgs of the drive transistor 105 is at this value in the initialization stage, the short-term image sticking can be alleviated. At this time, since the first control signal is at a high level and the fifth transistor 205 is not turned on, the light emitting display cannot be performed.

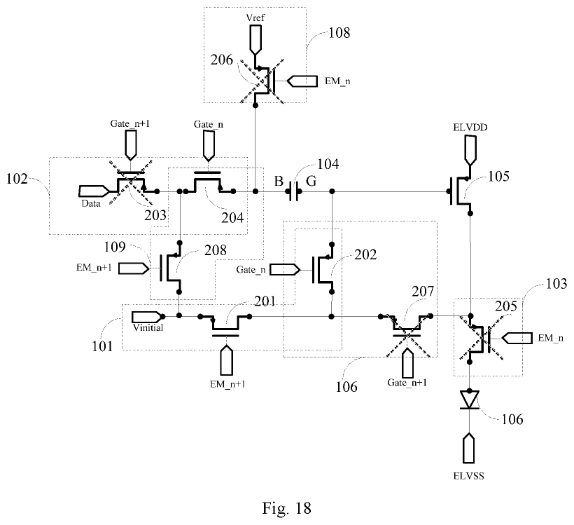

The second stage is the writing data stage, as shown in FIGS. 16 and 18.

At this time, the second drive signal and the third drive signal are at low level, the second control signal is at high level, the first control signal is at high level, and the second drive signal and third drive signal are effective, and thus the third transistor 203 and the fourth transistor 204 are driven to be turned on, that is, the data writing circuit 102 starts to work. Since the gate-source potential difference Vgs of the drive transistor 105 is less than Vth in the initialization stage, wherein the Vth is the threshold voltage of the drive transistor 105, the potential ELVDD of the first power supply input to the first electrode of the light emitting element 106 is written to the node “G” until the potential of the node “G” is ELVDD+Vth, that is, the compensation circuit 106 causes the threshold voltage of the drive transistor 105 to be compensated to the gate of the drive transistor 105. Since the third transistor 203 and the fourth transistor 204 are turned on, the data writing circuit 102 writes the written data Vdata to the node “B”.

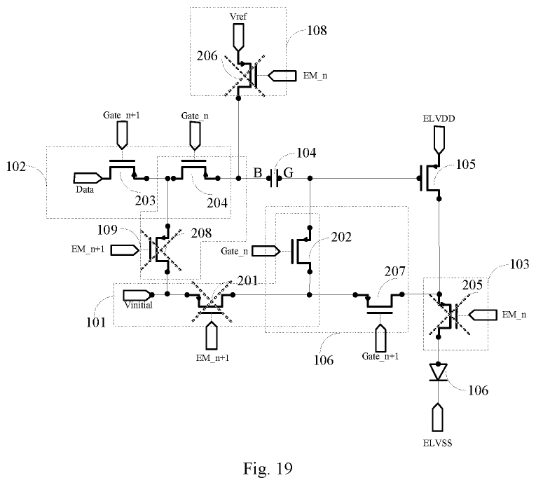

The third stage is the light emitting stage, as shown in FIGS. 16 and 19.

At this time, the second control signal and the second drive signal are at high level, the third drive signal is at low level, the first control signal is at low level, and thus the third drive signal and the first control signal are effective. At this time, the fifth transistor 205 is turned on, and the potential of the node “B” at the first terminal of the capacitor circuit 104 becomes the potential Vref of the holding power supply. At this time, the potential of the node “B” at the first terminal of the capacitor circuit 104 changes from Vdata to Vref, and the amount of its potential change is Vref-Vdata. The amount of its potential change is fed back to the node “G” at the second terminal of the capacitor circuit 104 to make the potential of the node “G” become ELVDD+Vth+Vref−Vdata, and thus the gate-source potential difference Vgs of the drive transistor 105 is Vgs=Vth+Vref−Vdata; since the fifth transistor 205 is turned on at this time, a current is formed between the first electrode and the second electrode of the light emitting element 106, and the current is I=K (Vref-Vdata)², wherein K is a coefficient. It can be seen that the current between the first electrode and the second electrode of the light emitting element 106 has no relation to the threshold potential Vth of the drive transistor 105.

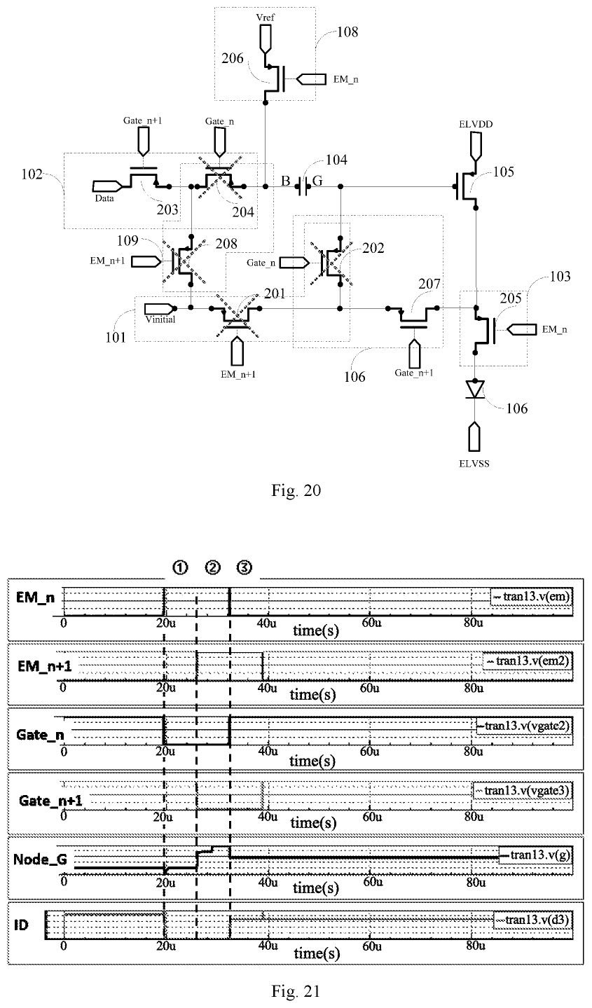

FIG. 20 is a circuit simulation diagram of the present embodiment. It can be seen from FIG. 20 that the potential and current of the node “G” at the second terminal of the capacitor circuit 104 are stable.

An embodiment of the present disclosure further discloses a display device which includes the pixel circuit provided by any of the embodiments of the present disclosure.

The units or circuits involved in the embodiments described in the present application can be implemented in software or hardware. The described units or circuits can also be provided in a processor. The names of these units or circuits do not constitute a limitation on the units or circuits themselves in some cases.

The above description is only an explanation of the preferred embodiments of the present application and the applied technical principles. Those skilled in the art should understand that the scope of the disclosure involved in this application is not limited to the technical solution formed by the specific combination of the above technical features, and should also cover other technical solutions formed by any combination of the above technical features or equivalent features thereof without departing from the inventive concept, such as the technical solutions formed by replacing the above features with the technical features with similar functions disclosed in this application (but not limited thereto).

What is claimed is:

1. A pixel circuit, comprising:
a first initialization sub-circuit, a data writing circuit, a light emitting control circuit, a capacitor circuit, a drive transistor, a compensation circuit, a light emitting element, and a holding circuit;
the first initialization sub-circuit is connected to a second terminal of the capacitor circuit and a gate of the drive transistor;
the data writing circuit is connected to a first terminal of the capacitor circuit, wherein the capacitor circuit is configured to store data to be written to the gate of the drive transistor in a data writing stage;
the light emitting control circuit is connected to a first electrode of the light emitting element and a second electrode of the drive transistor;
a first electrode of the drive transistor is connected to the first power supply, and the second electrode of the drive transistor is connected to the light emitting control circuit;
the compensation circuit is connected to the second electrode and the gate of the drive transistor, and is configured to perform potential compensation on the gate of the drive transistor when the data writing circuit writes data to the first terminal of the capacitor circuit;
a second electrode of the light emitting element is connected to a second power supply;
the holding circuit is connected to the first terminal of the capacitor circuit.

2. The circuit according to claim 1, wherein the first initialization sub-circuit comprises a first transistor and a second transistor;
a first electrode of the first transistor is connected to an initial power supply;
a second electrode of the first transistor is connected to a second electrode of the second transistor, a first electrode of the second transistor is connected to the gate of the drive transistor;
the first transistor outputs a potential of the initial power supply to the second electrode of the second transistor in response to a second control signal;
the second transistor outputs the potential of the initial power supply to the gate of the drive transistor in response to a second drive signal.

3. The circuit according to claim 1, wherein the data writing circuit comprises a third transistor and a fourth transistor;
a second electrode of the third transistor is connected to written data;
a first electrode of the third transistor is connected to a second electrode of the fourth transistor, a first electrode of the fourth transistor is connected to the first terminal of the capacitor circuit;
the third transistor writes the written data to the second electrode of the fourth transistor in response to a third drive signal;
the fourth transistor writes the written data to the first terminal of the capacitor circuit in response to a second drive signal.

4. The circuit according to claim 1, wherein the compensation circuit comprises a second transistor and a seventh transistor;
the second transistor is a transistor that is multiplexed by the compensation circuit and the first initialization sub-circuit;
a first electrode of the second transistor is connected to the gate of the drive transistor, a second electrode of the second transistor is connected to a first electrode of the seventh transistor;
a second electrode of the seventh transistor is connected to the second electrode of the drive transistor;
the seventh transistor causes a threshold voltage of the drive transistor to pass through the second electrode of the second transistor in response to a third drive signal;
the second transistor causes the threshold voltage of the drive transistor to be compensated to the gate of the drive transistor in response to a second drive signal.

5. The circuit according to claim 1, wherein the light emitting control circuit comprises a fifth transistor;
a first electrode of the fifth transistor is connected to the second electrode of the drive transistor, a second electrode of the fifth transistor is connected to the first electrode of the light emitting element;
the fifth transistor outputs a potential of the first power supply passing through the drive transistor to the first electrode of the light emitting element in response to a first control signal.

6. The circuit according to claim 1, wherein the holding circuit comprises a sixth transistor, a first electrode of the sixth transistor is connected to a holding power supply, a second electrode of the sixth transistor is connected to the first terminal of the capacitor circuit;
the sixth transistor outputs a potential of the holding power supply to the first terminal of the capacitor circuit in response to a second control signal.

7. The circuit according to claim 1, wherein the first initialization sub-circuit and the compensation circuit are dual-transistor circuits, wherein, a transistor in the first initialization sub-circuit is also multiplexed as a transistor in the compensation circuit.

8. The circuit according to claim 1, wherein the circuit further comprises a second initialization sub-circuit;
the second initialization sub-circuit is connected to the first terminal of the capacitor circuit, and is configured to complete initialization of the capacitor circuit;
the data writing circuit and the second initialization sub-circuit are dual-transistor circuits, wherein, a transistor in the second initialization sub-circuit is also multiplexed as a transistor in the data writing circuit.

9. The circuit according to claim 8, wherein the second initialization sub-circuit comprises a fourth transistor and an eighth transistor;
the fourth transistor is a transistor that is multiplexed by the data writing circuit and the second initialization sub-circuit;
a second electrode of the eighth transistor is connected to an initial power supply;
a first electrode of the eighth transistor is connected to a second electrode of the fourth transistor, a first electrode of the fourth transistor is connected to the first terminal of the capacitor circuit;
the eighth transistor outputs a potential of the initial power supply to the second electrode of the fourth transistor in response to a first drive signal;
the fourth transistor outputs the potential of the initial power supply to the first terminal of the capacitor circuit in response to a second drive signal.

10. A display device, comprising the pixel circuit according to claim 1.

11. The display device according to claim 10, wherein the display device comprises multiple pixel circuits arranged in an array, the multiple pixel circuits are divided into multiple lines of pixel circuits; the display device further comprises a gate driver circuit, a light emitting signal control circuit, and a first drive signal;
the gate driver circuit comprises a first shift register unit and a second shift register unit;
the first shift register unit and the second shift register unit are configured to output an input timing signal as a timing signal shifted by one bit, the first shift register unit input the output timing signal into the second shift register unit;
the light emitting signal control circuit comprises a first inverter unit and a second inverter unit;
the first inverter unit receives the timing signal output by the first shift register unit, and inverts the timing signal output by the first shift register unit, the second inverter unit receives the timing signal output by the second shift register unit, and inverts the timing signal output by the second shift register unit;
the first drive signal is input to the first shift register unit;
the first shift register unit, the second shift register unit, the timing signals output by the first shift register unit and the second shift register unit are output to each line of the pixel circuit.

12. A driving method of a pixel circuit applied to the pixel circuit according to claim 1, the driving method comprising:
in an initialization stage, connecting an initial power supply to the first initialization sub-circuit, and under the control of a second control signal and a second drive signal, turning on dual transistors of the first initialization sub-circuit, outputting an initial power supply potential Vinitial to the gate of the drive transistor so that a gate potential of the drive transistor is Vinitial, wherein a gate-source voltage difference Vgs of the drive transistor is Vinitial-ELVDD, the ELVDD is the first power supply;
in a data writing stage, connecting written data to the data writing circuit, and under the control of a third drive signal and a second drive signal, turning on dual transistors of the data writing circuit to write the data to the first terminal of the capacitor circuit, and under the control of the third drive signal and the second drive signal, the compensation circuit turning on dual transistors of the compensation circuit, making a threshold voltage of the drive transistor compensated to the gate of the drive transistor so that the gate potential of the drive transistor is ELVDD+Vth, wherein the Vth is the threshold voltage of the drive transistor;
in a light emitting stage, under the control of a first control signal, the light emitting control circuit turning on a transistor of the light emitting control circuit, turning on a connection between the first power supply and the first electrode of the light emitting element, controlling the light emitting element to emit light, and under the control of a second control signal, the holding circuit outputting a potential Vref of a holding power supply to the first terminal of the capacitor circuit, and feeding back a difference between potentials of the first terminal of the capacitor circuit in the light emitting stage and in the data writing stage to the gate of the drive transistor so that the gate potential of the drive transistor is ELVDD+Vth+Vref−Vdata, wherein the gate-source voltage difference Vgs of the drive transistor is Vth+Vref−Vdata;
the second drive signal and the first control signal are mutually reverse timing signals;
the third drive signal and the second control signal are mutually reverse timing signals;
the second drive signal is a timing shift signal of the third drive signal;
the first control signal is a timing shift signal of the second control signal.

13. A driving method of a pixel circuit applied to the pixel circuit according to claim 8, the driving method comprising:
in an initialization stage, connecting an initial power supply to the first initialization sub-circuit and the second initialization sub-circuit, and under the control of a second control signal and a second drive signal, turning on dual transistors of the first initialization sub-circuit and the second initialization sub-circuit, outputting an initial power supply potential Vinitial to the first terminal and the second terminal of the capacitor circuit, respectively, so that potentials of the first terminal and the second terminal of the capacitor circuit, and a gate potential of the drive transistor are Vinitial, wherein a gate-source voltage difference Vgs of the drive transistor is Vinitial-ELVDD, the ELVDD is the first power supply;
in a data writing stage, connecting written data to the data writing circuit, and under the control of a third drive signal and a second drive signal, turning on dual transistors of the data writing circuit to write the data to the first terminal of the capacitor circuit, and under the control of the third drive signal and the second drive signal, the compensation circuit turning on dual transistors of the compensation circuit, making a threshold voltage of the drive transistor compensated to the gate of the drive transistor so that the gate potential of the drive transistor is ELVDD+Vth, wherein the Vth is the threshold voltage of the drive transistor;
in a light emitting stage, under the control of a first control signal, the light emitting control circuit turning on a transistor of the light emitting control circuit, turning on a connection between the first power supply and the first electrode of the light emitting element, controlling the light emitting element to emit light, and under the control of the first control signal, the holding circuit outputting a potential Vref of a holding power supply to the first terminal of the capacitor circuit, and feeding back a difference between potentials of the first terminal of the capacitor circuit in the light emitting stage and in the data writing stage to the gate of the drive transistor so that the gate potential of the drive transistor is ELVDD+Vth+Vref−Vdata, wherein the gate-source voltage difference Vgs of the drive transistor is Vth+Vref−Vdata;
the second drive signal and the first control signal are mutually reverse timing signals;
the first drive signal, the second drive signal, and the third drive signal are timing signals that are shifted sequentially.

14. A driving method of a pixel circuit, applied to the pixel circuit according to claim 8, the driving method comprising:
in an initialization stage, connecting an initial power supply to the first initialization sub-circuit and the second initialization sub-circuit, and under the control of a second control signal and a second drive signal, turning on dual transistors of the first initialization sub-circuit and the second initialization sub-circuit, outputting an initial power supply potential Vinitial to the first terminal and the second terminal of the capacitor circuit, respectively, so that potentials of the first terminal and the second terminal of the capacitor circuit, and a gate potential of the drive transistor are Vinitial, wherein a gate-source voltage difference Vgs of the drive transistor is Vinitial-ELVDD, the ELVDD is the first power supply;
in a data writing stage, connecting written data to the data writing circuit, and under the control of a third drive signal and a second drive signal, turning on dual transistors of the data writing circuit to write the data to the first terminal of the capacitor circuit, and under the control of the third drive signal and the second drive signal, the compensation circuit turning on dual transistors of the compensation circuit, making a threshold voltage of the drive transistor compensated to the gate of the drive transistor so that the gate potential of the drive transistor is ELVDD+Vth, wherein the Vth is the threshold voltage of the drive transistor;
in a light emitting stage, under the control of a first control signal, the light emitting control circuit turning on a transistor of the light emitting control circuit, turning on a connection between the first power supply and the first electrode of the light emitting element, controlling the light emitting element to emit light, and under the control of the first control signal, the holding circuit outputting a potential Vref of a holding power supply to the first terminal of the capacitor circuit, and feeding back a difference between potentials of the first terminal of the capacitor circuit in the light emitting stage and in the data writing stage to the gate of the drive transistor so that the gate potential of the drive transistor is ELVDD+Vth+Vref−Vdata, wherein the gate-source voltage difference Vgs of the drive transistor is Vth+Vref−Vdata;
the second drive signal and the first control signal are mutually reverse timing signals;
the third drive signal and the second control signal are mutually reverse timing signals;
the second drive signal is a timing shift signal of the third drive signal;
the first control signal is a timing shift signal of the second control signal.
